(19) United States
(12) Patent Application Publication
(10) Pub. No.: US 2018/0283925 A1
(43) Pub. Date: Oct. 4, 2018

(54) Apparatus and Method for Measuring a Level of a Liquid

(71) Applicants: Larry Baxter, Orem, UT (US); David Frankman, Provo, UT (US); Aaron Sayre, Spanish Fork, UT (US)

(72) Inventors: Larry Baxter, Orem, UT (US); David Frankman, Provo, UT (US); Aaron Sayre, Spanish Fork, UT (US)

(21) Appl. No.: 15/472,660

(22) Filed: Mar. 29, 2017

(51) Int. Cl. G01F 23/24; G01F 25/00

(52) U.S. Cl. CPC G01F 23/246; G01F 25/0061

(57) ABSTRACT

An apparatus and method for measuring the level of a liquid. The apparatus includes an elongated probe comprising an electrically and thermally conductive material. The probe has an upper region to be disposed above the surface of the liquid, a lower region to be disposed below the surface of the liquid, and a middle region. A heater adds heat to the probe, and temperature sensors may measure the temperature of the probe in the upper and lower regions. Electrical circuitry may be used to control and receive signals from the various components and to measure the electrical resistance between a location in the upper region of the probe and a location in the lower region of the probe. The liquid level may be computed as a function of the measured values, the probe dimensions, and the known temperature dependence of the electrical resistance of the probe.

This invention was made with government support under DE-FE0028697 awarded by The Department of Energy. The government has certain rights in the invention.

### TECHNICAL FIELD

The disclosure relates generally to the field of liquid level measurement. Specifically, the disclosure relates to an apparatus and method for performing such measurements.

### BACKGROUND

Various methods and means exist for measuring the level of liquid substances in a vessel or reservoir. Some methods include: sight glasses, measuring hydrostatic pressure, and using a strain gauge device. The need still exists for an accurate, cost-effective, and quick method and accompanying apparatus for measuring the level of liquids.

### BRIEF SUMMARY

An apparatus for measuring the level of a liquid is described. The apparatus includes an elongated probe comprising an electrically and thermally conductive material. The probe comprises an upper region intended to be disposed above the surface of the liquid, a lower region intended to be disposed below the surface of the liquid, and a middle region between the upper region and the lower region. A heater is configured to add heat to the probe and thereby raise the average temperature along the length thereof, and temperature sensors are configured to measure the temperature of the probe in the upper region and in the lower region. The apparatus also includes electrical circuitry configured to perform at least the functions of controlling the heater, receiving signals from the temperature sensors, and measuring the electrical resistance between a first location in the upper region of the probe and a second location in the lower region of the probe.

A method of measuring the level of a liquid includes providing an elongated probe as described above, the upper region of the probe being disposed above the surface of the liquid and the lower region of the probe being disposed below the surface of the liquid. Heat may then be added to the probe to raise the average temperature along the length thereof and the temperature of the probe may be measured in the upper region and in the lower region. After the difference between the measured temperature of the probe in the upper region and the measured temperature of the probe in the lower region reaches a predetermined value, the electrical resistance may be measured between a first location in the upper region of the probe and a second location in the lower region of the probe. The level of the liquid may then be computed as a function of the measured temperature of the probe in the upper region, the measured temperature of the probe in the lower region, the measured electrical resistance of the probe between the first location and the second location, the length of the probe between the first location and the second location, and the known temperature dependence of the electrical resistance of the probe between the first location and the second location.

These and other features and objects of the present invention will become more fully apparent from the following description and appended claims, or may be learned by the practice of the invention as set forth hereinafter.

### BRIEF DESCRIPTION OF THE DRAWINGS

To further clarify the above and other features and advantages of the present invention, a more particular description of the invention will be rendered by reference to specific embodiments thereof which are illustrated in the appended drawings. It is appreciated that these drawings depict only exemplary embodiments of the invention and are therefore not to be considered limiting of its scope. These drawings are not necessarily to scale.

FIGS. 1 and 2 schematically illustrate perspective sectional views of an apparatus for measuring the level of a liquid in accordance with various exemplary embodiments; in the preferred embodiments the probe of the apparatus may be generally cylindrical; to generate the cross sections, a vertically-aligned plane intersects a central diameter of the top of the probe, and the line of sight may be perpendicular to the vertically-aligned plane.

FIG. 3 illustrates a top plan view of the apparatus depicted in FIG. 2, but without any liquid depicted. The view of FIG. 2 is a cross section taken at 301-301 from this FIG. 3. After comparing the relationship between FIG. 3 and FIG. 2, one skilled in the art would be able to understand that the sectional view depicted in FIG. 1 could be derived from an analogous top plan view that would be very similar to the one depicted in FIG. 3.

FIGS. 4 and 5 summarize a method for measuring the level a liquid in accordance with various exemplary embodiments.

### DETAILED DESCRIPTION

Reference will now be made to the exemplary embodiments illustrated in the drawings, and specific language will be used herein to describe the same. It will nevertheless be understood that these are merely representative examples of the invention and are not intended to limit the scope of the invention as claimed. Those of skill in the art will recognize that the elements and steps of the invention as described by example in the drawings could be arranged and designed in a wide variety of different configurations without departing from the substance of the claimed invention. Alterations and further modifications of the inventive features illustrated herein, and additional applications of the principles of the invention as illustrated herein, which would occur to one skilled in the relevant art and having possession of this disclosure, are to be considered within the scope of the invention.

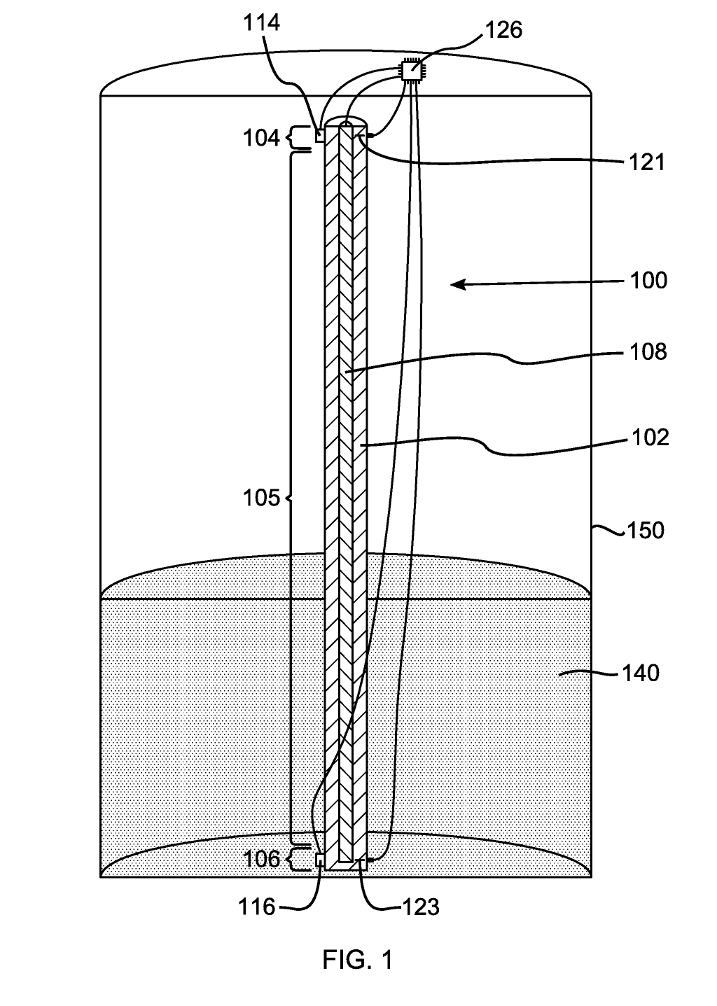

FIG. 1 illustrates an example of an apparatus 100 for measuring the level of a liquid 140 according to an embodiment of the invention. For illustration purposes, the liquid 140 is shown contained in a vessel 150, but the structure containing the liquid is not part of the claimed invention and can be any form of man-made or naturally-occurring container or reservoir.

The apparatus 100 may include an elongated probe 102 comprising an electrically and thermally conductive material. The probe 102 comprises an upper region 104 that may be disposed above the surface of the liquid 140, a lower region 106 that may be disposed below the surface of the liquid 140, and a middle region 105 between the upper region 104 and the lower region 106. The middle region 105 more or less defines the usable measuring region of the probe. Even though the example in FIG. 1 shows these three referenced regions 104-106 as being contiguous and covering the entire length of the probe 102, such contiguity and entirety of coverage on the probe are not requirements of the invention (although the probe 102 may itself be a mechanically contiguous feature). Also, the ratio of the lengths of these three referenced regions 104-106 as illustrated in FIG. 1 is only exemplary and not prescriptive, as this ratio can be varied widely by one skilled in the art to accommodate the design and performance parameters specific to the implementation of interest.

The apparatus 100 may also include a heater 108 configured to add heat to the probe 102 and thereby raise the average temperature along the length thereof. Because the probe 102 comprises a thermally conductive material, in the absence of the liquid 140 the temperature of the probe would be expected to be relatively uniform along its length, especially after the heater has been turned off and a reasonable equilibration time has elapsed. As a general rule, the more thermally conductive the probe material is, and the more uniformly the heat is added along the length of the probe 102 by the heater 108, the faster the temperature will equilibrate. A preferred configuration for rapidly and uniformly adding heat to the probe is illustrated in FIG. 1, wherein the heater 108 may comprise an elongated heating element running axially through the central portion of the probe 102. Preferably, such a heating element is electrically insulated from the probe itself. By way of example and not limitation, in one embodiment the heating element of heater 108 employs electrical resistance heating. In another embodiment the heater 108 comprises an electrical circuit that channels electrical current through the probe 102 such that the probe itself acts as an electrical resistance heating element. The foregoing list of examples is illustrative only and is not intended to be exclusive or exhaustive.

The presence of the liquid 140 in contact with the probe 102 measurably alters the temperature distribution along the probe, which is a key effect that enables the measurement of the liquid level. In particular, the liquid 140 acts as a heat sink, or thermal drain, to remove heat from the probe 102 via convective heat transfer in the region of contact. More specifically, the temperature distribution along the probe 102 will be a function of the convective heat transfer coefficient of whatever fluid material is in thermal contact with that portion of the probe. For present purposes, the environment above the surface of the liquid 140 may be assumed to be gaseous or vacuum. Because liquids generally have much higher convective heat transfer coefficients than gases or vacuum, the convective heat transfer coefficient profile can be expected to change measurably at the interface between the liquid 140 and the environment above it, resulting in a relatively sudden discontinuity in the temperature profile at that point, with the portion of the probe 102 that is in contact with the liquid 140 being at a lower temperature than the portion of the probe 102 that is above the surface of the liquid 140. This results in a corresponding discontinuity in the temperature-dependent material properties of the probe 102, including electrical resistivity. Thus, an electric current passing through the probe 102 from one end to the other may experience one resistivity before the discontinuity point and a different resistivity after the discontinuity point. By measuring the total resistance of the probe (or of a selected length of the probe containing the discontinuity point), the physical dimensions of the probe (or of the selected length of the probe), and the resistivity before and after the discontinuity point, one skilled in the art may then compute the location of the discontinuity point, which will coincide with the level of the liquid 140.

Because the electrical resistivities before and after the discontinuity point are temperature-dependent, as long as one knows how the resistivity of the probe varies with temperature, these two resistivities may be determined quite easily by measuring the temperatures of the probe 102 before and after the discontinuity point. Since the discontinuity point coincides with the surface of the liquid 140, the apparatus 100 may include a temperature sensor 114 configured to measure the temperature of the probe in the upper region 104 (which by definition is intended to be disposed above the surface of the liquid) and another temperature sensor 116 configured to measure the temperature of the probe in the lower region 106 (which by definition is intended to be disposed below the surface of the liquid). These temperature sensors may comprise thermistors, thermocouples, resistance temperature detectors (RTDs), silicon bandgap temperature sensors, semiconductor-based sensors, and/or any other temperature sensing device or devices.

The apparatus 100 may also include electrical circuitry 126 configured to perform at least the functions of controlling the heater 108, receiving signals from the temperature sensors 114 and 116, and measuring the electrical resistance between a first location 121 in the upper region 104 of the probe 102 and a second location 123 in the lower region 106 of the probe 102. The electrical circuitry 126 may perform other functions as well, including without limitation computing the level of the liquid, as described in greater detail below. The electrical circuitry 126 may make the electrical resistance measurement by sending an electric current through the probe 102 between the first location 121 and the second location 123 and measuring the voltage drop between those locations, then computing the resistance by dividing the voltage drop by the current.

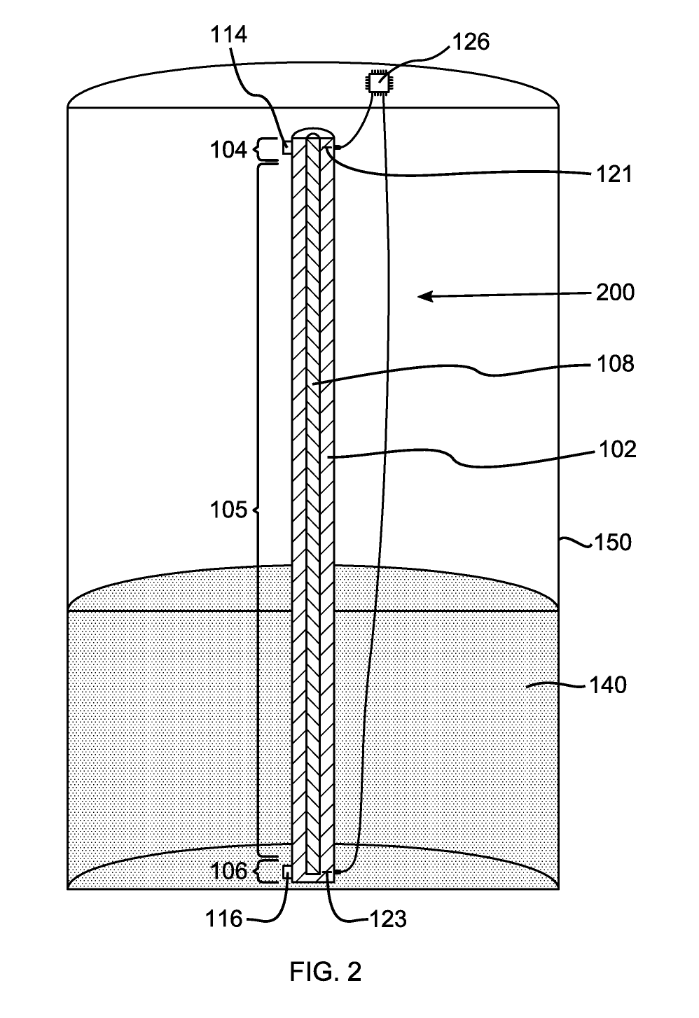

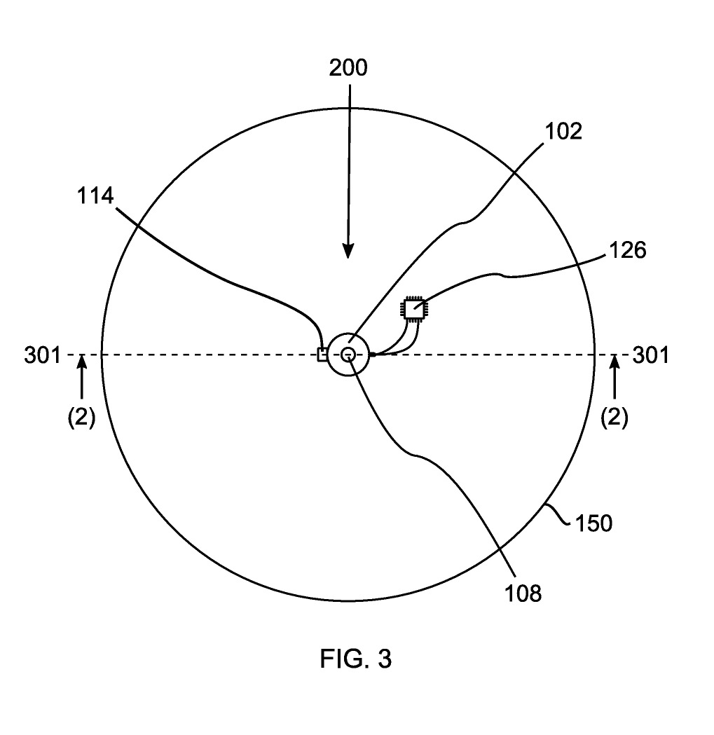

For convenience or cost savings or other reasons, the electrical circuitry 126 may be integrated in whole or in part onto a single printed circuit board or even a single integrated circuit (IC) chip, as illustrated in FIG. 1. Note that FIG. 1 shows electrical wires connecting the IC chip to the components it controls and/or communicates with, but the electrical circuitry 126 may also or alternatively employ wireless connections. By way of example and not limitation, FIGS. 2 and 3 illustrate an embodiment in which an apparatus 200 comprises electrical circuitry 126 which employs wireless connections to the heater 108 and the temperature sensors 114 and 116. Electrical circuitry of this nature, both wired and wireless, are well understood in the art and need no further elaboration here.

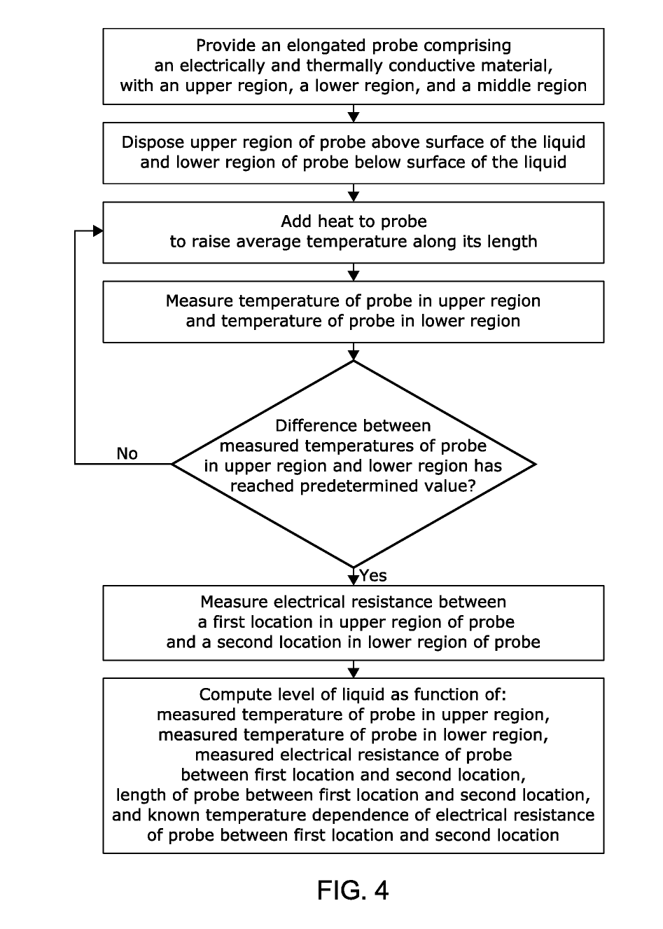

A method of measuring the level of a liquid using an apparatus as disclosed herein is summarized in FIG. 4. The method includes providing an elongated probe as described above, the upper region of the probe being disposed above the surface of the liquid and the lower region of the probe being disposed below the surface of the liquid. Heat may then be added to the probe to raise the average temperature along the length thereof, and the temperature of the probe may be measured in the upper region and in the lower region. After the difference between the measured temperature of the probe in the upper region and the measured temperature of the probe in the lower region reaches a predetermined value—which may be as small as one or two degrees or as large as hundreds of degrees, depending on the specifics of the application and the apparatus—the electrical resistance may be measured between a first location in the upper region of the probe and a second location in the lower region of the probe. The level of the liquid may then be computed as a function of the measured temperature of the probe in the upper region (referred to hereafter as Tᵤₚₚₑᵣ), the measured temperature of the probe in the lower region (referred to hereafter as T_{lower}), the measured electrical resistance of the probe between the first location and the second location (referred to hereafter as Rₜₒₜₐₗ), the length of the probe between the first location and the second location (referred to hereafter as lₜₒₜₐₗ), and the known temperature dependence of the electrical resistance of the probe between the first location and the second location. A more detailed discussion of this computation follows.

As long as the probe material has a much higher electrical conductivity than the liquid, the measured resistance Rₜₒₜₐₗ may be taken to be the sum of the resistance attributable to the portion of the probe above the surface of the liquid (referred to hereafter as R_{dry}) and the resistance attributable to the portion of the probe below the surface of the liquid (referred to hereafter as R_{wet}):

Rₜₒₜₐₗ=R_{dry}+R_{wet}

In general, the resistance R of a conductor of length l with a uniform cross-sectional area A may be expressed as R=ρ(l/A), where ρ is the electrical resistivity of the material. The above equation thus becomes:

$${R}_{total} = {ρ}_{dry} ( \frac{{l}_{dry}}{{A}_{dry}} ) + {ρ}_{wet} ( \frac{{l}_{wet}}{{A}_{wet}} )$$

where the dry and wet subscripts refer to the portion of the probe above the surface of the liquid and the portion of the probe below the surface of the liquid, respectively. To account for thermal expansion experienced by the probe, which may be different for the dry and wet portions of the probe, we can rewrite the above equation as:

$${R}_{total} = {ρ}_{dry} ( \frac{{l}_{dry 0} [ 1 + ∝ ( {T}_{upper} - {T}_{0} ) ]}{{{A}_{0} [ 1 + ∝ ( {T}_{upper} - {T}_{0} ) ]}^{2}} ) + {ρ}_{wet} ( \frac{{l}_{wet 0} [ 1 + ∝ ( {T}_{lower} - {T}_{0} ) ]}{{{A}_{0} [ 1 + ∝ ( {T}_{lower} - {T}_{0} ) ]}^{2}} )$$

where ∝ is the coefficient of thermal expansion of the probe material in the temperature range of interest, T₀ is a base temperature at which thermal expansion is deemed to be zero, A_{σ} is the cross-sectional area of the probe measured at temperature T₀, and the subscripts dry0 and wet0 refer to the respective dry and wet values as they would be at temperature T₀. (As used in this specification and the appended claims, the term “thermal expansion” includes thermal contraction.) This equation can then be simplified to:

$${R}_{total} = {ρ}_{dry} ( \frac{{l}_{dry 0}}{{A}_{0} [ 1 + ∝ ( {T}_{upper} - {T}_{0} ) ]} ) + {ρ}_{wet} ( \frac{{l}_{wet 0}}{{A}_{0} [ 1 + ∝ ( {T}_{lower} - {T}_{0} ) ]} ) .$$

Solving for l_{wet0} and using the identity lₜₒₜₐₗ₀=l_{dry0}+l_{wet0} gives the following result:

$${l}_{wet 0} = [ 1 + ∝ ( {T}_{lower} - {T}_{0} ) ] ( \frac{{R}_{total} {A}_{0} [ 1 + ∝ ( {T}_{upper} - {T}_{0} ) ] - {ρ}_{dry} {l}_{total 0}}{{ρ}_{wet} [ 1 + ∝ ( {T}_{upper} - {T}_{0} ) ] - {ρ}_{dry} [ 1 + ∝ ( {T}_{lower} - {T}_{0} ) ]} )$$

Finally, replacing this into the identity l_{wet}=l_{wet0}[1+∝(T_{lower}−T₀)] provides an equation from which l_{wet} may be computed:

$${l}_{wet} = {[ 1 + ∝ ( {T}_{lower} - {T}_{0} ) ]}^{2} ( \frac{{R}_{total} {A}_{0} [ 1 + ∝ ( {T}_{upper} - {T}_{0} ) ] - {ρ}_{dry} {l}_{total 0}}{{ρ}_{wet} [ 1 + ∝ ( {T}_{upper} - {T}_{0} ) ] - {ρ}_{dry} [ 1 + ∝ ( {T}_{lower} - {T}_{0} ) ]} )$$

Referring back to FIG. 1, lₜₒₜₐₗ₀ would be the length of the probe 102 between the first location 121 and the second location 123 as measured at temperature T₀, and l_{wet} would be the length of the probe 102 between the first location 121 and the surface of the liquid 140 at temperature T_{lower}. Thus, in order to compute l_{wet}, which will tell us the level of the liquid 140 on the probe 102, the above equation requires us to supply certain material properties of the probe, namely: ∝, which is the coefficient of thermal expansion of the probe material; ρ_{dry}, which is the electrical resistivity of the probe material at temperature Tᵤₚₚₑᵣ; and ρ_{wet}, which is the electrical resistivity of the probe material at temperature T_{lower}. These values may be readily determined from published and/or privately measured properties of the probe material covering the temperature range of interest.

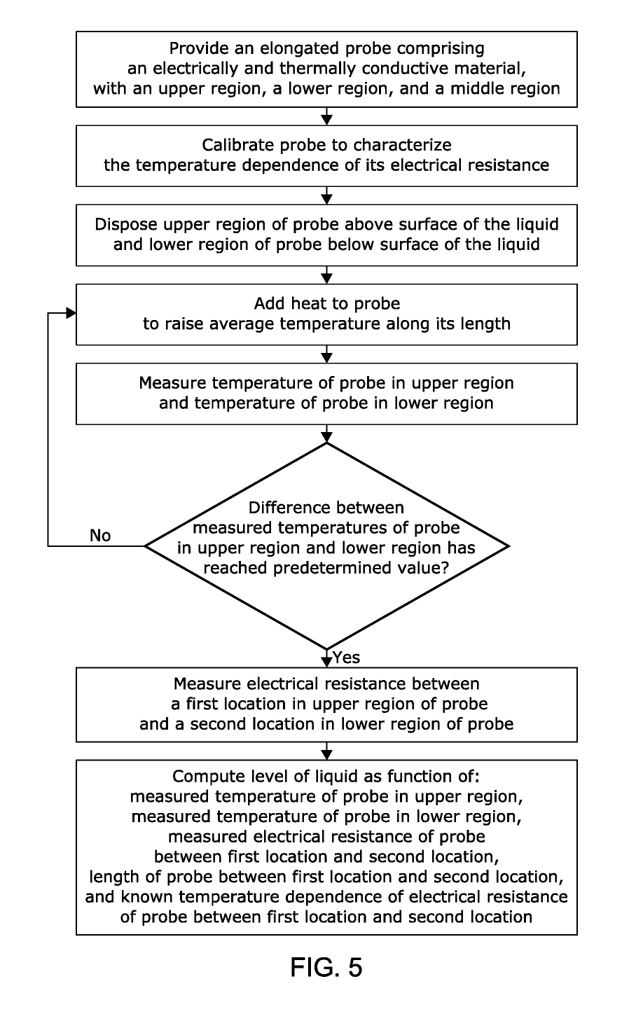

Instead of relying solely on measured properties of the probe material to determine pay and ρ_{wet}, superior accuracy may be achieved by calibrating the probe itself to characterize the temperature dependence of the electrical resistance of the probe. Thus, in one embodiment, a calibration step is added for this purpose, as shown in FIG. 5. Such calibration may include, for example, measuring the electrical resistance per unit length of the probe across a range of temperatures.

Yet another way to improve the accuracy of the above method is to add an equilibration step, in which the heater may be turned off and the probe may be allowed a period of time, such as between 1 second and 10,000 seconds, for local temperature equilibration before final temperature and resistance measurements are made. The purpose of this step is to ensure sufficient temperature uniformity within the portion of the probe above the surface of the liquid and sufficient temperature uniformity within the portion of the probe below the surface of the liquid so as to achieve the desired degree of accuracy and precision in the resulting liquid level measurements produced by the apparatus. The length of the equilibration time should therefore be long enough to achieve the desired degree of temperature uniformity within each of these two portions of the probe, but not so long that the temperature difference between these two portions of the probe drops below the level necessary to achieve a measurement with the desired degree of accuracy and precision. By way of example and not limitation, it is envisioned that equilibration times between 1 second and 10 minutes may be advantageous for many applications and apparatus embodiments.

Returning now to a consideration of the apparatus itself, the choice of specific material or materials for the probe depends on the application, but in general the guiding considerations include chemical compatibility with the liquid or liquids of interest, relatively high thermal conductivity, and relatively strong temperature dependence for the electrical resistivity p of the material. By way of example and not limitation, the following materials are among the many materials that may be useful as probe materials: materials that are known for changing resistance as a function of temperature, such as those used in a thermistor may be used; ceramics; polymers; metallic oxides of iron, manganese or copper; metals such as stainless steel or copper. The specific material may be dependent on the temperature range to which the material may be exposed.

Those of skill in the art will also appreciate that there are many potentially useful probe designs and configurations. The most basic design would be a straight rod with a circular cross section, as illustrated in the foregoing drawings, but many other cross-sectional shapes may be advantageously employed, either along the entire length of the probe or just a portion thereof. Further, the probe need not be straight. By way of example and not limitation, a probe in the shape of a helix may be advantageous in that it may provide greater length lₜₒₜₐₗ and resistance Rₜₒₜₐₗ, which can potentially improve the accuracy and/or precision of the resulting liquid level measurement.

Any computations referenced herein may be performed by electrical circuitry which includes circuit boards or computer servers known in the art.

For any figure depicting numbered elements that are not expressly described in connection with that figure, the descriptions of those numbered elements in connection with the first figure in which they are depicted may be applied.

While the invention has been shown in the drawings and described above with particularity and detail in connection with what are presently deemed to be some of the more practical and preferred embodiments of the invention, these embodiments are illustrative only and are not intended to be exhaustive or to limit the invention to the forms disclosed. It will be apparent to practitioners skilled in the art that numerous variations, combinations, and equivalents can be devised without departing from the principles and concepts of the invention as set forth herein. The invention should therefore not be limited by the above-described embodiments, methods, and examples, but by all embodiments and methods that are within the scope and spirit of the invention as disclosed and claimed.

We claim:

1. An apparatus for measuring the level of a liquid, comprising:
(a) an elongated probe comprising an electrically and thermally conductive material, said probe comprising an upper region to be disposed above the surface of the liquid, a lower region to be disposed below the surface of the liquid, and a middle region between the upper region and the lower region;
(b) a heater adding heat to the probe and thereby raising the average temperature along the length thereof;
(c) a temperature sensor measuring the temperature of the probe in the upper region;
(d) a temperature sensor measuring the temperature of the probe in the lower region; and
(e) electrical circuitry performing at least the functions of controlling the heater, receiving signals from the temperature sensors, and measuring the electrical resistance between a first location in the upper region of the probe and a second location in the lower region of the probe.

2. The apparatus of claim 1, wherein at least a portion of the probe has a generally circular cross section.

3. The apparatus of claim 1, wherein at least a portion of the probe is substantially helical in shape.

4. The apparatus of claim 1, wherein the thermally conductive material comprises a material selected from the group consisting of ceramics, polymers, metallic oxides of iron, metallic oxides of manganese, metallic oxides of copper, stainless steel, and copper.

5. The apparatus of claim 1, wherein the heater comprises an elongated heating element running axially through the central portion of the probe.

6. The apparatus of claim 1, the heater employing electrical resistance heating.

7. The apparatus of claim 6, wherein the heater comprises an electrical circuit channeling electrical current through the probe such that the probe itself acts as an electrical resistance heating element.

8. The apparatus of claim 3, the heater employing electrical resistance heating.

9. The apparatus of claim 8, wherein the heater comprises an electrical circuit channeling electrical current through the probe such that the probe itself acts as an electrical resistance heating element.

10. The apparatus of claim 1, wherein at least one of the temperature sensors comprises a thermister.

11. The apparatus of claim 1, wherein at least one of the temperature sensors comprises a thermocouple.

12. The apparatus of claim 1, wherein at least one of the temperature sensors comprises a resistance temperature detector.

13. The apparatus of claim 1, wherein at least one of the temperature sensors comprises a semiconductor-based temperature sensor.

14. The apparatus of claim 1, wherein at least one of the temperature sensors comprises a silicon bandgap temperature sensor.

15. The apparatus of claim 1, the electrical circuitry employing wireless connections to at least one member of the group consisting of the heater and each of the temperature sensors.

16. The apparatus of claim 1, the electrical circuitry further performing the function of computing the level of the liquid.

17. A method of measuring the level of a liquid, comprising the steps of:
(a) providing an elongated probe comprising an electrically and thermally conductive material, said probe comprising an upper region to be disposed above the surface of the liquid, a lower region to be disposed below the surface of the liquid, and a middle region between the upper region and the lower region;
(b) disposing the upper region of the probe above the surface of the liquid and the lower region of the probe below the surface of the liquid;
(c) adding heat to the probe to raise the average temperature along the length thereof;
(d) measuring the temperature of the probe in the upper region and the temperature of the probe in the lower region;
(e) after electrical circuitry has determined that the difference between the measured temperature of the probe in the upper region and the measured temperature of the probe in the lower region has reached a predetermined value, measuring the electrical resistance between a first location in the upper region of the probe and a second location in the lower region of the probe;
(f) computing the level of the liquid as a function of the measured temperature of the probe in the upper region, the measured temperature of the probe in the lower region, the measured electrical resistance of the probe between the first location and the second location, the length of the probe between the first location and the second location, and the known temperature dependence of the electrical resistance of the probe between the first location and the second location.

18. The method of claim 17, further comprising a calibration step to characterize the temperature dependence of the electrical resistance of the probe between the first location and the second location.

19. The method of claim 17, further comprising an equilibration step wherein the heater is turned off and the probe is allowed a period of time for local temperature equilibration before final temperature and resistance measurements are made.

20. The method of claim 19, wherein the period of time allowed for local temperature equilibration is between 1 second and 10 minutes, inclusive.
